(19) United States
(12) Patent Application Publication
(10) Pub. No.: US 2005/0114705 A1
(43) Pub. Date: May 26, 2005

(54) Method and system for discriminating a human action from a computerized action

(76) Inventors: Eran Reshef, Lehavim (IL); Gil Raanan, Zoran (IL); Eilon Solan, Petah Tikva (IL)

Correspondence Address: BROWN, RAYSMAN, MILLSTEIN, FELDER & STEINER LLP, 900 THIRD AVENUE, NEW YORK, NY, 10022, US

(21) Appl. No.: 10/790,611

(22) Filed: Mar. 1, 2004

Related U.S. Application Data
(63) Continuation of application No. 09/209,727, filed on Dec. 11, 1998, now abandoned.
(60) Provisional application No. 60/069,202, filed on Dec. 11, 1997.

(51) Int. Cl. H04L 9/00; H04L 9/32; G06F 11/30; G06F 12/14

(52) U.S. Cl. 713/201

(57) ABSTRACT

A method and system are disclosed for discriminating automatic computerized action from a human performed action. The invention is based on applying human advantage in applying sensory and cognitive skills to solving simple problems that prove to be extremely hard for computer software. Such skills include, but are not limited to processing of sensory information such as identification of objects and letters within a noisy graphical environment, signals and speech within an auditory signal, patterns and objects within a video or animation sequence. Human skills also include higher level cognitive processing such as understanding natural language and logical assignments. The method for discriminating between humans and computerized actions can be used during authentication, to limit access by automated agents, and for confirmation of actions.

### RELATED APPLICATIONS

This application is related to pending provisional application No. 60/069,202 titled METHOD AND SYSTEM FOR VERIFYING THAT A HUMAN IS ACCESSING A COMPUTERIZED RESOURCE, filed Dec. 11, 1997, which is hereby incorporated by reference into this application.

### BACKGROUND OF THE INVENTION

This invention relates generally to a method and a system for discriminating automatic computerized action from a human performed action. In particular, the present invention relates to a method and system for verifying that a human is replying to a challenge issued by a computerized resource.

The need for discrimination between human activity and automatic computerized activity arises in several different domains of computer data processing, such as authentication, controling automatic software agents, and confirmation of actions.

### Authentication

With respect to digital communications, authenticating the identity of parties is an important issue. Communication between parties often is accomplished through a computerized interface. Even more often, one party is communicating with a computerized resource, such as accessing a database, performing on-line transactions or participating in e-commerce. In this case, it is often required to verify the identity of the communicating party. Many technologies exist which allow verification or authentication of a user to take place, such as passwords, digital signatures, biometrics devices and hardware tokens.

However, all these identification methods are susceptible to “brute force” attacks. “Brute force” attacks refers to repeatedly accessing the resource and trying one possible key at a time, over and over again until a correct “guess” is stumbled upon. The process of guessing one possible key after another in a sequence in order to “crack” a password is called “enumerating on a keyspace.” A “keyspace” is the totality of permutations for an authentication system. For example, a PIN (personal identification number) of 6 digits, has a keyspace of 10⁶ (one million) keys. Brute force attacks are actually limited only by the time needed to enumerate each of the possible keys, and by the cost of making the communication attempts to the computerized resource. To continue the above example, if a computer can make 1,000 attempts per second, it will take a maximum of 20 minutes (1,000 seconds) to find the correct PIN.

The cost of the call is usually not a significant problem. Many so called “hackers” can take advantage of the Internet which provides a virtually free and anonymous communication medium. Other communication mediums, such as phone calls, can often be manipulated to be free of charge. In other cases, an attack is carried out on an isolated device, such as a digital cash smart-card.

With most systems the main protection against brute force attack lays in the size of the keyspace and the number of permutations of keys. However, in most cases the hacker can reduce the keyspace size considerably by gathering some basic information and designing a logical protocol before starting the attack. For example, since many people prefer to use common words as their user password, a hacker usually needs to only check dictionary words, and not all possible character combinations. Other authentication devices, such as hardware tokens might require some heavy study before starting the attack, but nonetheless can be averted.

The fact is, no matter how large the keyspace, and how complex the passwords chosen, only computer processing power and speed limit the amount of time required for cracking the password scheme. In fact, attempts to make a password scheme more complex can often provide clues to the hacker in defining a logical protocol for planning an attack. For instance, if a password scheme requires the user to have a password that includes non-letter characters, this fact can be used to narrow down the range of possibilities in the keyspace.

Brute force attacks can often be detected by watching out for repeated communication attempts from a particular location, especially by tracking for wrong-password events, or for unusual patterns such as calling from unknown locations at off hours. However, this method is notoriously known for mistakenly detecting legitimate users who are attempting to access the computer resource, or who mistakenly made an error in entering their own password too many times. Since this form of protection is usually followed by locking up the computerized resource or service, it offers an indirect way for a hacker to perform a different attack such as a denial-of-service. In sum, up until now, there has been no effective way to detect and stop brute force attacks.

In short, authentication devices used up to date can be compromised by repeatedly trying keys for the authentication system until finding the correct combination. This task is often performed by an automated device, such as a computer program. By forcing a human response to a request for a password, brute force attacks become innately time consuming. In fact, requiring a human response makes the task of automatically enumerating on a keyspace much more demanding and complicated.

### Automatic Software

Many businesses use the Internet to allow public access to important business information, such as price lists. However, even though the proprietors would like to make the information available to the public, they would not like the information to be retrieved by computer programs or autonomous agents.

Even non-malicious agents, which are not intended to do harm to the user, may cause indirect losses due to the information they access and distribute. Examples include search bots which scan web-sites. These increase the load on the computers of the site by performing a huge amount of requests. Another type of bot performs “comparison shopping” by accessing all sites offering certain goods for sale and finding the site with the best price. Naturally, not all proprietors of e-shops would like to allow this kind of bot to access their site.

In addition to giving access to information, in many cases businesses enable customers and business partners to perform transactions with the business through the Internet. Malicious agents or viruses attempt to perform transactions using information acquired from hijacked communication or from a user's computer. Examples of such masquerading include performing e-commerce transactions on behalf of a user without his knowledge or consent, or causing harm to the integrity of information residing on sites accessible to the unaware user.

### Human Confirmation

The designers of certain systems would like to require human attention when the system is used. One example is the use of confirmation dialogs in shareware or in other software. Usually, during the evaluation period, a shareware software product will keep reminding the user of the fact that it is only an evaluation copy. Similarly, certain software will request a confirmation before executing critical commands, such as “delete file” or “format disk”. However, such confirmation dialogues are easily breached by simple programs. Programmers, or computer hackers, can write a program which automatically dismisses the confirmation thereby defeating the very purpose of the confirmations dialogue—requiring the user to take note.

All the above cases demonstrate the need for a method and system which helps discriminate actions taken by humans from automated or computerized actions.

### SUMMARY OF THE INVENTION

Accordingly, it is an object of this invention to solve the problems with existing systems described above.

It is another object of this invention to provide a system and method for discriminating automatic computerized action from a human performed action.

It is another object of this invention to create challenges which exploit human sensory and cognitive characteristics to reduce system responses to automatic means.

It is another object of this invention to strengthen existing authentication schemes by making enumerating on a keyspace much more complex and difficult for automatic devices.

It is another object of this invention to reduce access of automatic software, both benign and malicious, to computerized resources.

It is another object of this invention to prevent bypassing of confirmation dialogues by automatic means.

These objects and other advantages are provided by a system and method for discriminating automatic computerized action from a human performed action. The invention is based on a challenge-response pair that comprises a human ability challenge system. The invention supplies challenges that can be met easily by humans due to their sensory or cognitive capabilities; capabilities that are not easily matched by either computer hardware or software.

The invention relates to exploitation of the human ability to solve sensory or cognitive challenges better than computer systems and to the human advantage in applying sensory and cognitive skills to solve simple problems that are extremely hard for automatic devices. The critical factor is whether a human being has an innate ability that is far superior to the ability of a computer to recognize or process the information presented. These challenges may be any of the following types:

1. A visual challenge such as identifying objects, letters or words that were transformed by rotations, skewing, scaling, etc., to complicate computerized or automatic analysis. The visual stimuli are in the domains of two dimensional (2D), three dimensional (3D) or video animation. One implementation of the visual challenge is based on identification of letters displayed as graphic objects. For example, the challenge is to recognize 4 letters which have been distorted in various ways. Distortion is applied to stop non-naïve attacks using methods such as OCR. Distortion may include different fonts and sizes, rotation around a certain axis, and filtering through different patterns. The distorted letters are then combined to a single graphical object using random placing. The whole object is then encoded using an information-losing encoding method, such as JPEG, to prevent easy reconstruction.

2. An auditory challenge such as sound and speech recognition. The sounds may also be passed through various filters for distortion of the sound.

3. A cognitive challenge such as understanding natural language or applying logic.

4. A challenge combining sensory and cognitive elements such as recognizing an object and, based on such recognition and the understanding of natural language, performing a required action.

The invention is applied by adding a human ability component to existing systems or by integrating such a component to a new system. When activated, such component selects a type of human ability challenge, randomly generates a response appropriate to the type of challenge selected, uses a challenge creating engine to create a challenge matching the response generated, sends the challenge so created, and compares a received response to the correct response.

The comparison of the response received to the correct response may be implemented in several ways. An exemplary method is encrypting the correct response, sending the challenge and encrypted correct response, returning a response and the encrypted correct response, and decrypting the encrypted correct response and comparing it to the response received. Another exemplary method is hashing the correct response, sending the challenge and the hash of the correct response, returning a response and the hash of the correct response, and hashing the response so received and comparing the result to the hash of the correct response.

An additional exemplary method is generating a random key, entering the correct response into a table kept in the component indexed by the random key so generated, sending the challenge and the key, returning a response and the key, and comparing the correct response indexed by the key and the response returned.

The component may be integrated into many possible architectures. Several embodiments of the invention are implemented in the client-server environment. In some embodiments, the above component runs on a proxy server which is physically separate from the application server or any physical client. In another embodiment, the component runs on the application server itself. In still other preferred embodiments, the system can be implemented in domains that do not belong to the client-server methodology. In one embodiment, the component is integrated into computer software directly.

One exemplary area in which the invention is employed is in the area of authentication mechanisms or schemes. Many authentication schemes are vulnerable to brute-force attacks. The invention strengthens such schemes against such automatic attacks by adding a challenge requiring human reply to the authentication challenge. In such a case a brute force attack becomes highly impractical because with every authentication challenge issued, a new human ability challenge is generated. In order to be able to perform a brute force attack, the attacker must either reply to the human ability challenge manually, or create an automatic method for doing the same. The likelihood of correctly answering a human ability challenge of recognizing 6 letters given one opportunity, without a human participant, is 1/(26)⁶.

Another exemplary area in which the invention is employed is the prevention of non-malicious automatic software components such as information gathering agents or bots from retrieving information which is meant by the provider to be available only to humans. Some exemplary non-malicious automatic software performs price-comparison by accessing on-line sales systems which have pricing information. These automatic agents retrieve and save pricing information for comparison purposes. The same methods described above are-used to reduce access by automatic software while enabling all humans to view pricing information.

Another exemplary area in which the invention is employed is in the area of protection against malicious automatic software such as computer viruses. Among other things, such viruses may collect information about a proprietary system, such as passwords, by listening to communications or scanning resources, such as disks. The malicious software may then utilize the passwords collected to access the proprietary system and view information or perform unauthorized actions therein. The same methods described above are used to reduce intrusion by such computer viruses by requiring a human to respond to a challenge before allowing access to the proprietary system. This reduces the possibility that the computer virus may be employed purposefully to cause damage to the proprietary system.

Another exemplary area in which the invention is employed is in the area of verifying that the respondent to a confirmation dialog is a human rather than an automated device. For example, programmers may write programs which automatically give affirmative replies to confirmation dialog boxes such as those used to confirm deletion of files. In these cases, human attention is required in order to prevent loss of data. The invention prevents automated replies to such dialog boxes.

Another exemplary implementation exists in shareware protection. Shareware type software often includes dialog type reminders which appear periodically to remind users to purchase a license to use the software after an evaluation period. The motivation for presenting such dialogs during shareware usage is that users will eventually become sufficiently annoyed to decide to purchase a license or registered version of the software to avoid having to see the dialog box. Mal-intending programmers, or hackers, have developed work-arounds which feign acknowledgment of the dialogs so that they do not appear to the user. By embedding the above component into shareware so that a human ability challenge is presented with the dialog box, the effectiveness of such work-arounds is either significantly reduced, or eliminated.

### BRIEF DESCRIPTION OF THE DRAWINGS

For a fuller understanding of the invention, reference is made to the following description taken in connection with the accompanying drawings, in which:

FIG. 1 is a diagram representing an architecture of a system of particular embodiments of the present invention;

FIG. 2 is a flow diagram showing a process of creating, presenting and verifying a human ability challenge in accordance with particular embodiments of the present invention;

FIGS. 3 and 4 are flow diagrams showing processes for generating human ability challenges in accordance with alternative embodiments of the present invention;

FIG. 5 represents an exemplary challenge executing an embodiment of the present invention using two dimensional letters for a human ability challenge;

FIG. 6 represents an exemplary challenge executing an embodiment of the present invention using pictorial objects for a human ability challenge;

FIG. 7 is represents an exemplary challenge executing another embodiment of the present invention using two dimensional letters for a human ability challenge further incorporating a cognitive skills challenge;

FIG. 8a is a diagram representing a prior art exemplary computer screen.

FIG. 8b is a diagram representing an exemplary computer screen executing another embodiment of the present invention incorporated with a standard user name and password authentication system;

FIG. 9 is a message flow diagram showing an authentication system in accordance with particular embodiments of the present invention;

FIG. 10 is a flow diagram showing the flow of data of an authentication system in accordance with particular embodiments of the present invention;

FIG. 11 is a block diagram of human ability challenge proxy subroutine in accordance with preferred embodiments of the present invention; and

FIG. 12 is a flow diagram showing a process of limiting access to computerized resources by on-line automated agents.

### DETAILED DESCRIPTION OF THE PREFERRED EMBODIMENTS

The preferred embodiments of the invention are now described with reference to the drawings in the figures.

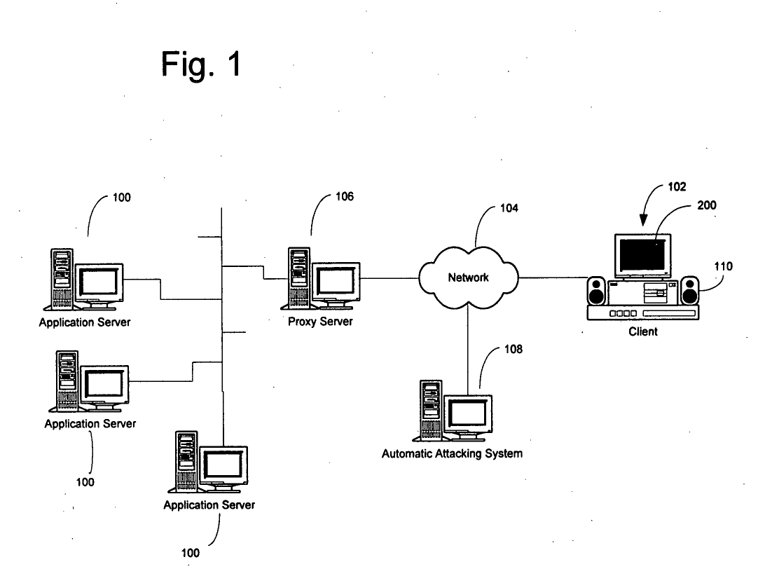

With reference to FIG. 1, a diagram representing an architecture of systems of some embodiments of the present invention is shown based on a proxy mediator in a client/server model. Although this architecture is used for much of the description that follows, one skilled in the art will recognize that many different computer architectures may be used to present the human ability challenge, including a single computer running an application program with a built-in human ability challenge routine or a proxy human ability challenge routine.

As shown in FIG. 1, an application server 100 provides computer resources to users who access the system through a client 102. Client 102 includes UI (user interface) means such as a screen 200 and an audio component 110. The client communicates with the server through a network 104 which may comprise a local area network, wide area network, the Internet or other network typologies. In between the network and the application server is a proxy server 106 which is used as a protection or interception barrier implementing a proxy program to protect computer resources on application server 100.

Given that the system of FIG. 1 is connected to a network, an automated rogue or attacking system 108 can intrude onto the system to try to access the computer resources which are only meant to be accessed by humans. This is especially possible when network 104 is a public network such as the Internet. Attacking system 108 can easily gain electronic access to application server 106 in most cases.

Although computer resources, and the application server itself may be protected by such techniques such as password or code protection, digital signatures, biometrics devices or hardware tokens, those systems have inherent problems which are described above. Thus, a proxy program executing on proxy server 106 stands as a barrier between an attacking system 108 and application server 100.

In some preferred embodiments of the invention, the proxy program on proxy server 106 receives an authentication challenge and adds the human only challenge for presentation to a user on client 102. The user is required to input an answer which is transmitted to the proxy server along with verification data preveiously transmitted from 106. The user's response is then checked on proxy server 106 by comparing it against a correct answer or verification data.

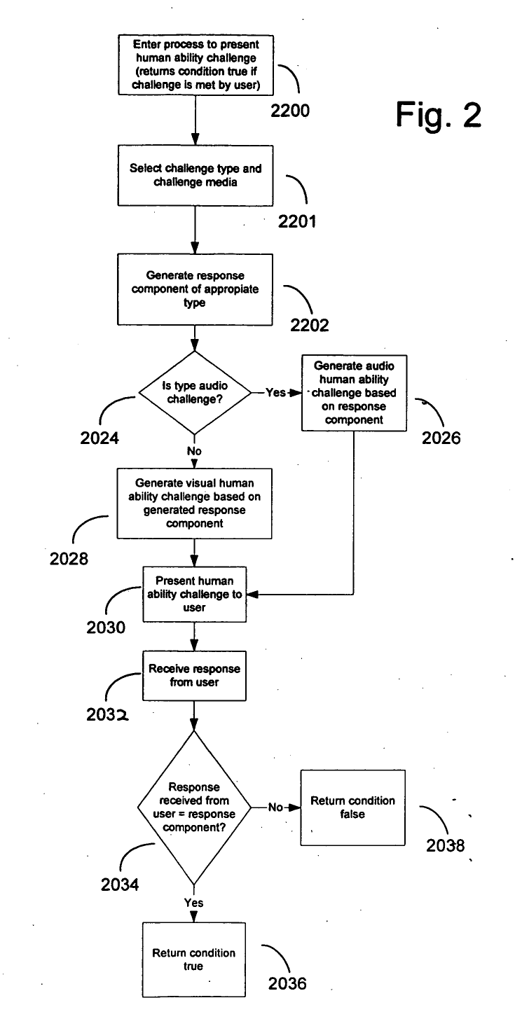

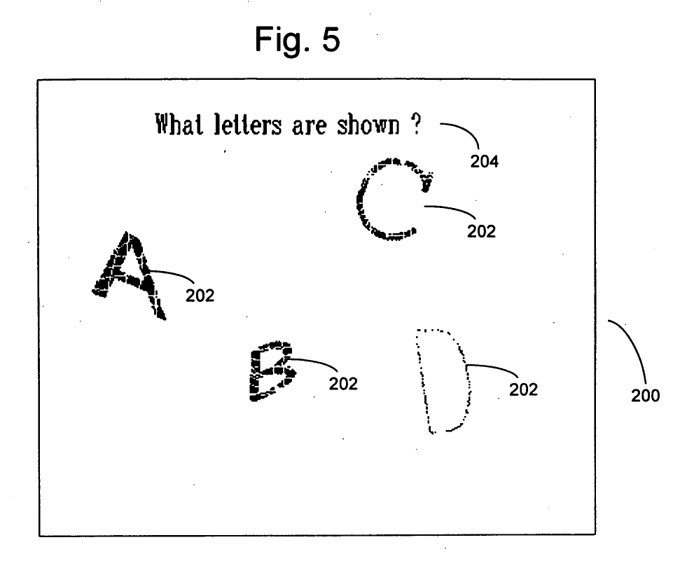

The processes of generating and using human ability challenges to discriminate between human actions and computerized actions is now described with reference to the flow charts in FIGS. 2-4 and the exemplary human ability challenges shown in FIGS. 5-8b.

Referring to FIG. 2, a flow diagram illustrating the general process for generating, and receiving and verifying the answer to a human ability challenge is shown. When called by a computer resource, the human ability challenge process executes for returning true if the human ability challenge is answered correctly and false if not, step 2200. The process selects a type of challenge (including media), step 2201. The process selects the type of challenge from an existing list of available challenge types. The list includes various types of challenges such as those which require a user to recognize distorted graphical letters, or which require the user to recognize distorted pictures of objects, or which require the user to answer an audio question which is randomly distorted by the process to prevent automated voice recognition techniques.

Next, the process generates a response component appropriate to the type selected, representing the correct answer to the human ability challenge as explained in more detail below with reference to FIGS. 34, step 2202. If the type of challenge requires presenting an object or objects, then a word or words representing the object is/are the appropriate response. If the type of challenge is an audio or visual alphanumeric challenge, then the proper response component would be alphanumeric. In that case, it may be preferrable to use random alphanumeric characters so that the challege is less susceptible to a brute force attack.

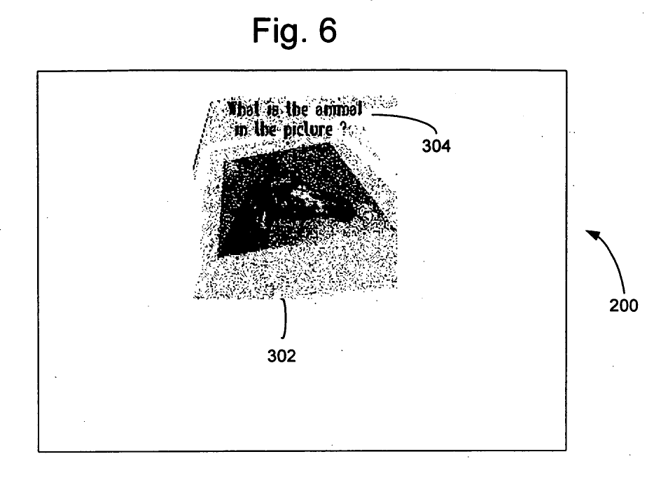

Alternatively, in the case of types of challenges which require cognitive ability, such as where an audible question is asked, or a picture for identification is presented, the response component is not randomly generated, but rather is selected from a database of availabe response components and human ability challenges. For example, in the case of pictorial types of challenges, the process may select the word “giraffe” from the database of response components. From a related database table, a picture of a giraffe is retreived for processing wherein the human ability challenge will comprise identifying a distorted picture of the giraffe (See FIG. 6 below). In order to avert naïve attacks on the human ability challege, the picture is randomly distorted in multiple dimensions so that the same human ability challenge is never presented more than once. The same technique is used in the case of audible types of challenges which require cognitive ability to answer.

If the type chosen requires the challenge to be presented audibly, step 2024, the process generates an audio human ability challenge based on the response component generated in step 2202, and on the type selected in step 2201, step 2026. Otherwise, a visually-presented human ability challenge is generated based on the response component, and on the type selected in step 2201, step 2028. The generated human ability challenge is then presented, step 2030. The process then waits for a response to the human ability challenge to be received, step 2032. The process verifies that the response received in step 2032 matches the response component generated in step 2202, step 2034. If the response received is verified the process returns true, step 2036. Otherwise, the process takes one of several possible actions such as returning false to signal the calling process that the human ability challenge was not answered correctly, step 2038; or by droping the connection with the user; or by returning an error message to the user, etc.

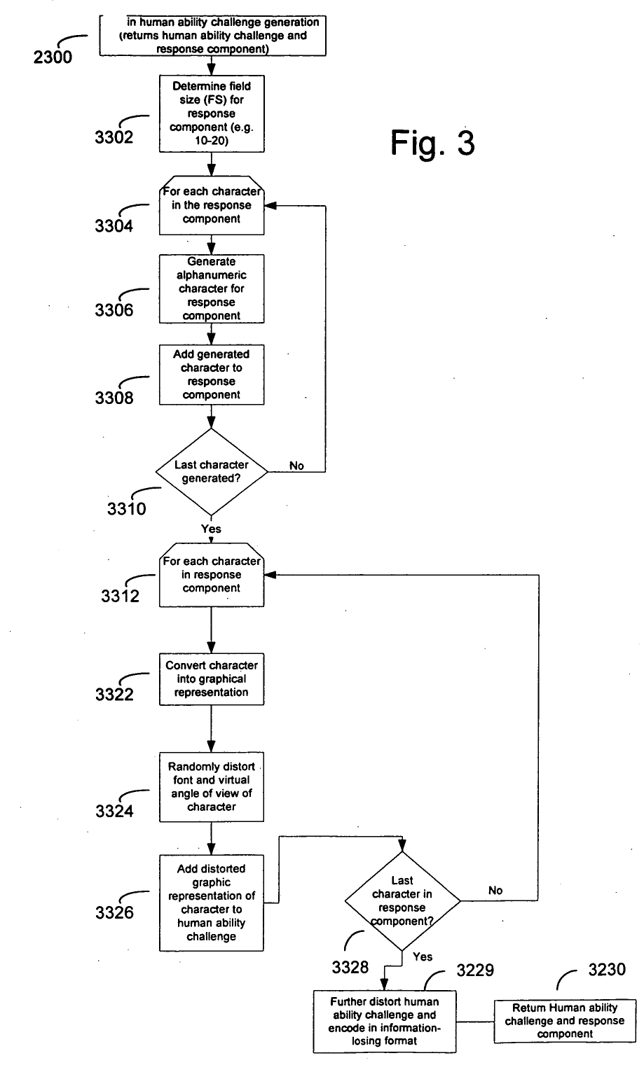

One process for generating human ability challenges of the type “visual recognition of distorted alphanumeric characters” is shown in FIG. 3. The generating process of FIG. 3 executes for the purpose of returning an alphanumeric based human ability challenge, and a response component to be compared with a received response for verification, step 2300. A field size of a response component is selected randomly from a range of sufficentily large numbers, step 3302, which determines the number of characters generated for the response component. The process executes a program loop to generate random characters for the response component, step 3304.

Within the loop, an alphanumeric character is randomly selected, step 3306. The random character is added to the character string of the response component, step 3308. The loop checks for an end of field indication for the response component, step 3310. If the response component field has not been filled, processing returns to step 3304 for further character generation. Otherwise execution leaves the loop.

After the response component has been determined, the process executes a loop for generating a human ability challenge based on the response component, step 3312. The process loop reads each character of the response component and adds the character to the human ability challenge being generated. Each character is converted into a graphical representation, step 3322. The font, the virtual angle of view and other attributes of the character are randomly distorted to hinder optical character recognition (OCR) which may be applied in an attempt by an automated process to avert the human ability challenge, step 3324. The distorted, graphic representation of the character is added to the human ability challenge, step 3326.

The process checks to see if the last character in the response component has been processed into the human ability challenge, step 3328. If not, then processing is returned to step 3312. Otherwise, the process applies a final distortion to all the human ability challenge and encodes it using an information-losing means, step 3329. Then, the process returns the human ability challenge and the response component to the calling process, step 3230.

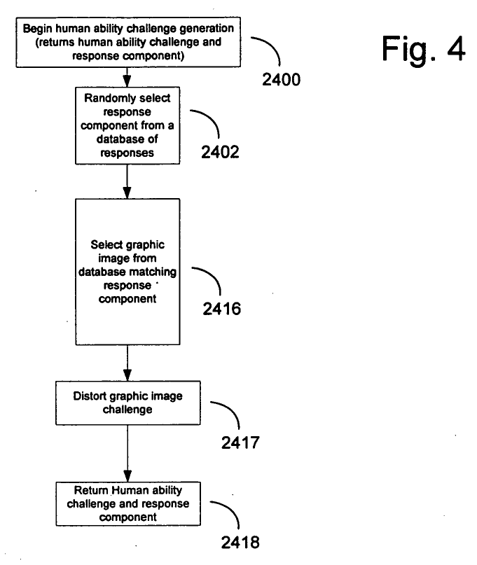

An example of a process for generating a human ability challenge of the type “recognition of a graphical object” is shown in FIG. 4. The generating process of FIG. 4 executes for the purpose of returning a pictorial based human ability challenge, and a response component to be compared with a received response for verification, step 2400. A response component is randomly selected from a database of possible responses, step 2402. A graphic image is matched with the response component from a pictorial database, step 2416. The graphic image chosen is then distorted randomly by skewing, rotation, coloring, adding “graphic noise”, etc, step 2417.

The response component together with the human ability challenge is returned to the calling process, step 2418.

With reference to FIG. 5, exemplary of the process described in FIG. 3, the human ability challenge of one embodiment is based on identification of letters 202 displayed as graphic objects on client screen 200. The number of letters 202 displayed, or keyspace size, is variable. For example, for a PIN size of six alphanumeric characters, the probability of finding the correct response using a single naïve attack is 1/(26+26+10)⁶. To stop non-naïve attacks on the invention using mechanisms such as OCR, distortions are applied differentially to letters 202. Distortion may include different fonts and sizes, rotation around a certain axis, and filtering through different patterns. Letters 202 are then combined to a single graphical object using random placing. The whole object is then distorted a final distortion (such as random placing) and encoded using information-losing encoding such as JPEG to prevent easy reconstruction. The challenge is then presented on screen 200, along with a question such as “What are the letters presented?”, 204, to a user who enters an answer which is verified before allowing entry into the computer resource on server 100. If the proxy program on proxy server 106 verifies that the correct answer, then the proxy program allows further processing to continue between client 102 and application server 100.

With reference to FIG. 6, in another embodiment of the present invention exemplary of the process described in FIG. 4, the human ability challenge comprises presenting a challenge of identification of one or a plurality of graphic images 302 on screen 200. As with identification of letters 202 (FIG. 5), the user must identify a visual object seen on screen 200, which, in this case, comprises an image 302 for which a user must provide a textual description of what is seen as indicated to the user at 304.

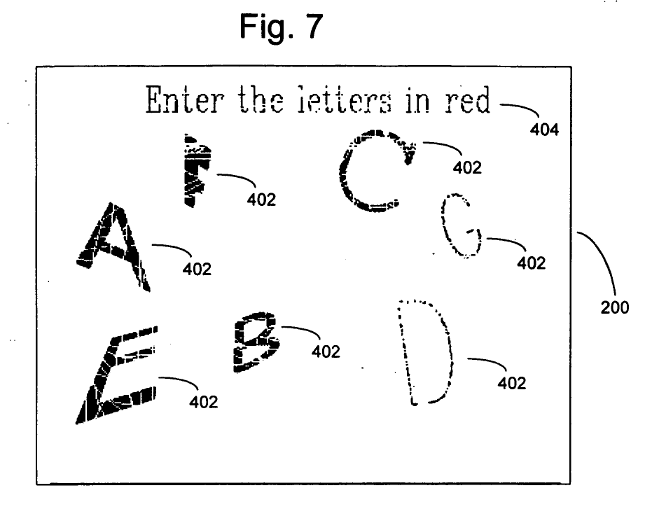

With reference to FIG. 7, other embodiments of the present invention not only exploit the sensory ability of humans, but incorporate exploitation of cognitive abilities as well. The challenge illustrated in screen 200 in FIG. 7 is similar to FIG. 5 except a cognitive element is added. While the challenge illustrated in FIG. 5 comprises simply identifying the distorted letters 202 on screen 200, the challenge illustrated in FIG. 7 comprises identifying at least one cognitive aspect of at least some of letters 402. In FIG. 7, the challenge comprises a question 404 which in this case inquires which letters are presented in the color red. The user is required to use sensory ability to detect letters 402 on screen 200, and then cognitive ability to distinguish the red letters of letters 402 from the non-red letters.

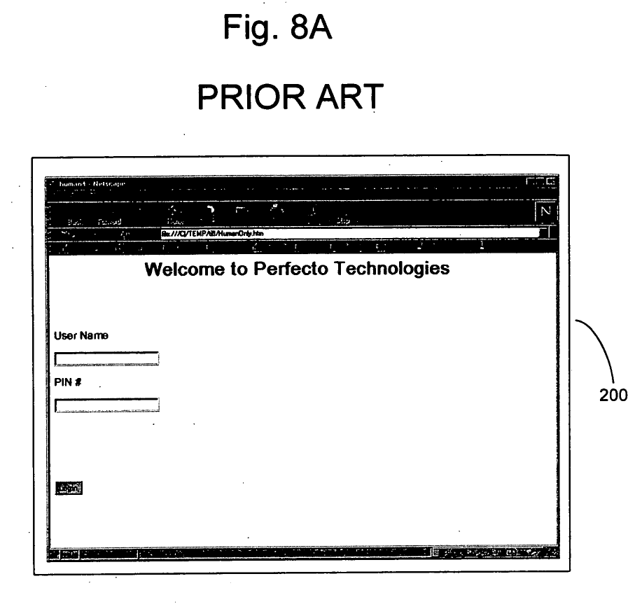

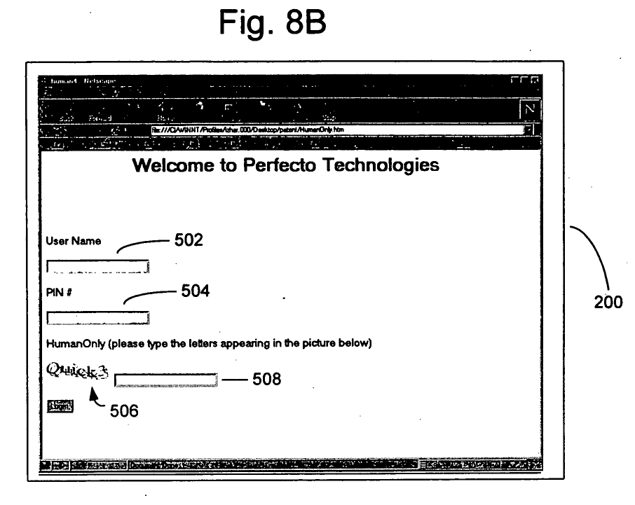

With reference to FIG. 8b, a specific embodiment of the present invention is used as a means for preventing naïve or brute force attacks by automatic attacking system 108 on password or code protected systems on application server 100. In common password protected systems, users who have access to a particular resource are issued a user name and secret password, PIN, or code number. When a user desires to access the system, the user is required to provide the username and code which is verified before entry is allowed into the system. This type of entry screen is illustrated in FIG. 8a For the embodiment illustrated in FIG. 8b, screen 200 is for presenting an Internet or Intranet html compatible browser screen which presents a user name prompt 502 and a personal identification number (PIN#) prompt 504 to the user of client 102. Unlike standard systems (FIG. 8a), though, a human ability challenge 506 and prompt 508 is presented. In order for a user to gain access to a particular computer resource on application server 100, the user must provide a valid username, PIN# and an answer to human ability challenge 506. The proxy program on proxy server 106 verifies that the answer provided in prompt 508 to human ability challenge 506 is correct. If the answer is verified, the proxy program allows access for client 102 to application server 100. However, the application server 100 nevertheless checks that the user name and PIN # or code entered at prompt 502 and 504 are valid before allowing access.

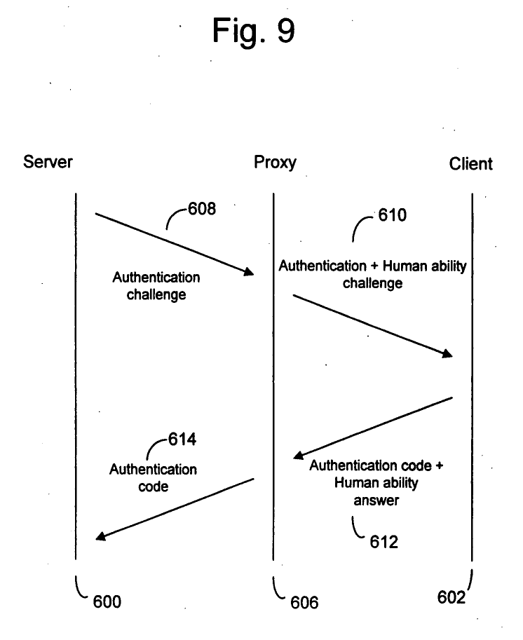

With reference to FIG. 9, a message flow diagram is illustrated representing the flow of data for the system of FIG. 8b. Line 600 represents an application server layer as shown in FIG. 1. Server layer 600 represents the application server 100 of FIG. 1. A proxy layer 606 represents proxy server 106 of FIG. 1. A client layer 602 represents client 102 of FIG. 1.

In FIG. 9, the server layer transmits an authentication challenge to proxy layer 606, step 608. Step 608 may take the form seen in FIG. 8a. Proxy layer 606 adds a human ability challenge to the authentication challenge and transmits the combined challenge to client layer 602, step 610. Step 610 may take the form of FIG. 8b. At client layer 602, client 102 receives from a user codes which are meant as an attempt to satisfy the authentication challenge, in the case of the system of FIG. 8 a user name and PIN#, and an answer to the human ability challenge, step 612. Within proxy layer 606, the answer to the human ability challenge is verified. If the correct answer to the human ability challenge was received, proxy layer 606 transmits the authentication codes to server layer 600, step 614, which verifies the authentication codes before allowing access to the computer resource.

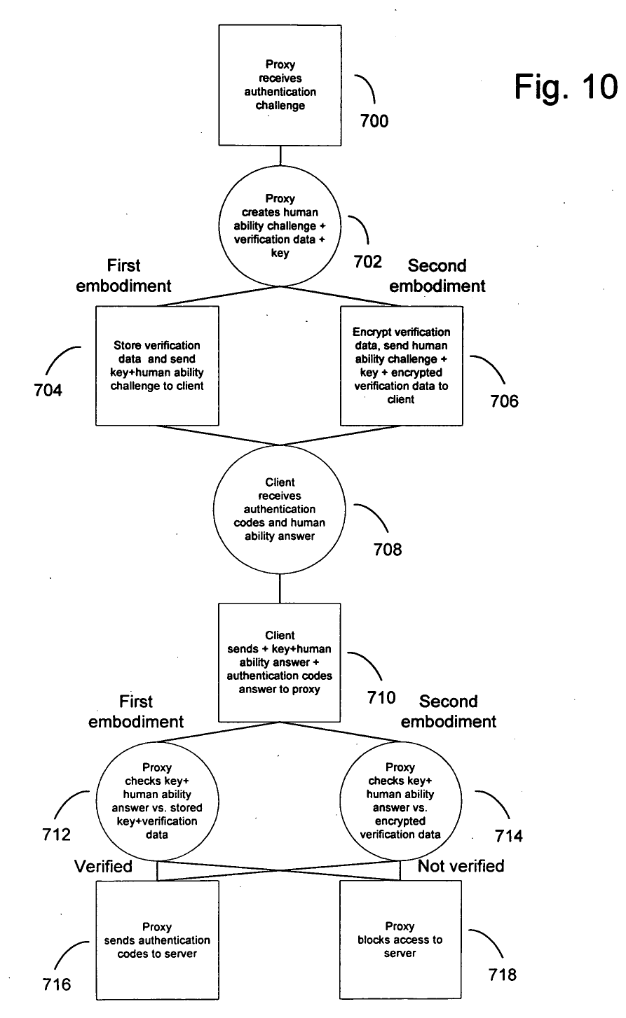

With reference to FIG. 10, a flow diagram of the system of FIGS. 8 and 9 is illustrated. The proxy program executing on proxy server 106 (FIG. 1) in proxy layer 606 (FIG. 9) receives an authentication challenge from application server 100 (FIG. 1), server layer 600 (FIG. 9), step 700. The proxy program creates a human ability challenge, verification data string (correct response), and a verification key, step 702.

In a first embodiment, the verification data (correct response) and key are stored on proxy server 106, and the key and the human ability challenge are transmitted to client 102 (FIG. 1), step 704. In a second embodiment, the verification data (correct response) is encrypted and transmitted to client 102 with the human ability challenge and key.

A user enters authentication codes, in this case user name and PIN, in response to presentation of both authentication prompts 502 and 504 (FIG. 8b), and enters an answer 508 to the human ability challenge 506 which is also presented on client 102, step 708. Client 102 transmits the authentication codes and human ability answer to proxy 106, step 710.

In the first embodiment, proxy 106 receives the authentication code, the human ability answer and key and verifies the human ability answer by checking against the previously stored verification data by relating the stored key with the transmitted key, step 712. In the second embodiment, proxy 106 receives the encrypted verification data, human ability answer and key, decrypts the verification data, and checks the human ability answer with the verification data, step 714.

If the proxy program of proxy 106 verifies that the human ability answer matches the verification data, proxy 106 transmits the authentication code to application server 100 for verification, step 716. If the proxy program returns a negative verification, then the proxy program does not transmit the authentication data to application server 100, and further access to the computer resource is prevented until another attempted entry is executed, step 718.

Along with, or instead of, a visually based human ability challenge, an audio based challenge may be presented. For example, proxy 106 may transmit a wav or other multimedia audio file type to client 102 for presentation on audio component 110. Instead of presenting text in screen 200 in FIG. 7 asking the question which letters are red, the audio file may be presented to ask the question for the challenge. Alternatively, instead of presenting letters 202 on screen 200 in FIG. 5, a distorted or noisy audio signal may be presented which audibly tells the user which letters are to be included in the answer to the human ability challenge to gain access. In the latter alternative, the proxy program on proxy 106 creates the audio file in real time by choosing among a random selection of letters or numbers which will be presented using a voice synthesizer. As the letters are selected they are added to the verification data which is used to verify the answer provided from client 102.

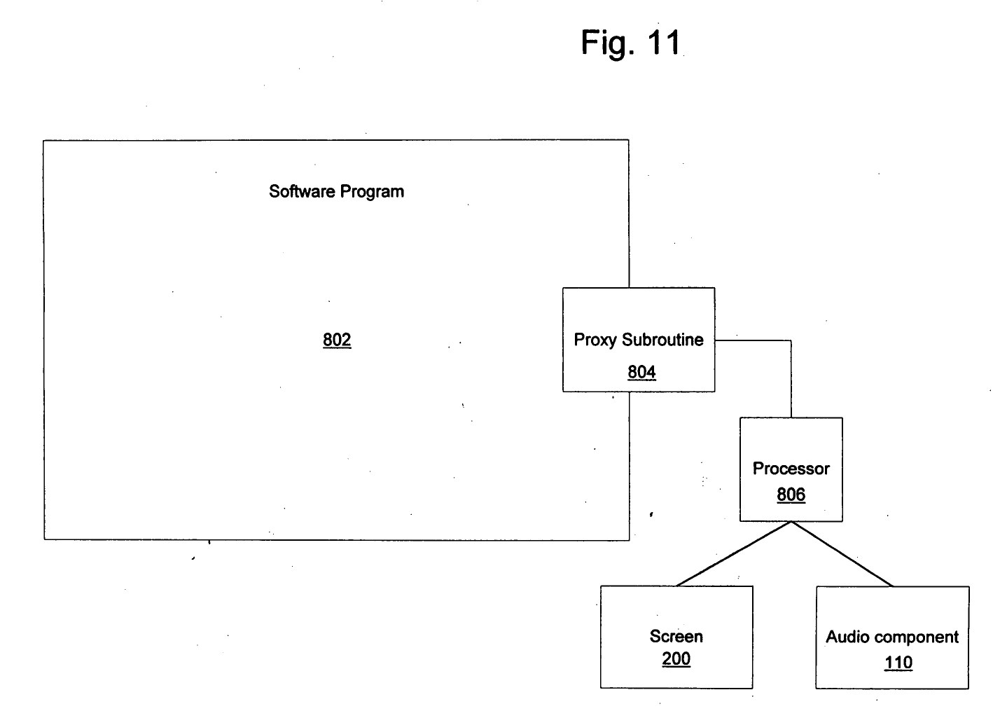

With reference to FIG. 11, often, a computer resource does not reside on a stationary system such as that illustrated in FIG. 1. Rather, the computer resource comprises software which is distributed either over a network to reside on remote systems, or distributed on media such as CD ROM or floppy disks. For software distribution, when it is desired to ensure that humans are accessing the software, it is impractical to force users to dial in to a proxy server from their system in order to use the resource. Thus, the proxy program is embedded as a subroutine directly into distributed software.

An exemplary area where the proxy program subroutine of the present invention is useful is in the area of shareware. Usually, during the evaluation period a shareware software product keeps reminding the user about the fact that it is only an evaluation copy. The problem with shareware conformation is that a simple hacking program can breach the confirmation. Programmers, or computer hackers, can write a program which automatically dismisses the confirmation without the need for the user to perform the confirmation. The same problem arises for systems which employ confirmation utilities for when users try to perform significant activities, such as deleting files.

A software program for distribution 802 for execution on a processor 806 has a proxy subroutine 804 embedded directly into it. A dialog box for prompting the user of software program 802 which the user is meant to respond to is set to be presented at certain points in the execution. At those points, proxy subroutine 804 creates a human ability challenge in real time, in the manner described in FIGS. 2-4. Proxy subroutine 804 stores the verification data in temporary memory in a random memory location. Proxy program 804 causes processor 806 to present the human ability challenge either on screen 200 or audio component 110.

The user responds to the human ability challenge with an answer, which proxy subroutine 804 verifies against the verification data stored in temporary memory. If the answer is verified, proxy subroutine 804 returns control to software program 802 for further processing. If the answer does not match the verification data, proxy subroutine 806 generates a new human ability challenge for re-presentation.

In order to protect against code breaking by hackers, proxy subroutine 804 may employ key encryption on the verification data. When the answer to the human ability challenge is returned to proxy subroutine 804, it is encrypted with the same key for verification.

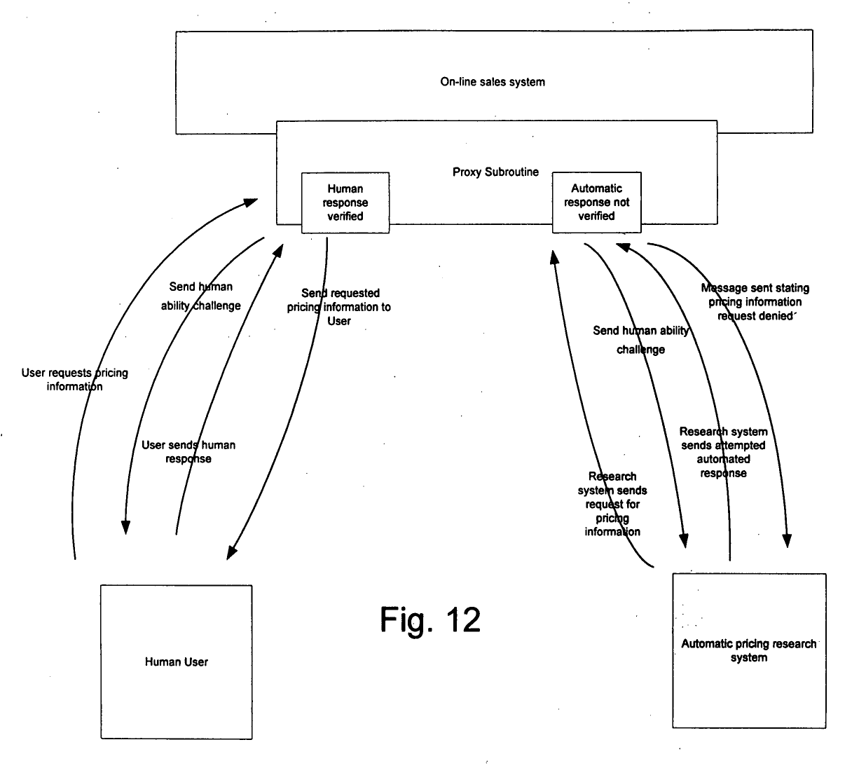

Another exemplary embodiment of a process employing a human ability challenge to discriminate between human and computerized action and stopping automatic software is shown in FIG. 12. An On-line sales system 1200 is available to a human user 1202 for pricing and purchasing of goods or services. However, an automated pricing research system 1204 may be employed by competitors of on-line sales system 1200 for collecting pricing data for underselling on-line sales system 1200.

In order to avoid access by research system 1204, on-line sales system 1200 employs the present invention embodied in a proxy 1206, in the form of a subroutine or server, which a system user must contend with to retrieve pricing information.

Human user 1202 may request pricing information, step 1208 from on-line system 1200. Proxy 1206 activates to block the request temporary so that a human ability challenge can be generated and sent back to human user 1202, step 1210. Human user 1202 provides the correct response to the human ability challenge, step 1212. Upon verification, step 1214, proxy 1206 clears on-line sales system 1200 for sending the requested pricing information to human user 1202, step 1216.

However, research system 1204 may also send a request for pricing information to on-line sales system 1200, step 1218. In response, proxy 1206 sends a human ability challenge to research system 1204, step 1220. For more sophisticated automated systems, an attempted automated response may be sent in answer to the human ability challenge, step 1222. However, due to the human cognitive sensory nature of the human ability challenge, the answer invariably will not be sufficient to be verified, step 1224, and a message is sent to research system 1204 stating so, step 1226.

While the invention has been described and illustrated in connection with preferred embodiments, many variations and modifications as will be evident to those skilled in this art may be made without departing from the spirit and scope of the invention, and the invention is thus not to be limited to the precise details of methodology or construction set forth above as such variations and modification are intended to be included within the scope of the invention.

1-32. (canceled)

33. A method employed in discriminating an action performed by a human from automatic computerized action, the method comprising:
presenting a human ability challenge having a response component, the human ability challenge having distorted content to reduce the possibility of computerized identification of the content;
receiving a response to the human ability challenge; and
comparing the received response to the response component to thereby help determine whether the received response was provided by a human.

34. The method of claim 33, comprising generating the human ability challenge.

35. The method of claim 34, wherein the step of generating the human ability challenge comprises generating the response component and generating the human ability challenge using the response component.

36. The method of claim 35, wherein the step of generating the response component comprises randomly generating the response component.

37. The method of claim 35, wherein the step of generating the human ability challenge comprises creating a distorted visual representation of the response component.

38. The method of claim 35, wherein the step of generating the human ability challenge comprises creating a distorted audio representation of the response component.

39. The method of claim 33, comprising selecting a type of human ability challenge from a plurality of human ability challenge types.

40. The method of claim 39, wherein the step of selecting the type of human ability challenge comprises randomly selecting the type of human ability challenge.

41. The method of claim 39, comprising determining the respondent's identity, and wherein the step of selecting the type of human ability challenge comprises selecting the type of human ability challenge based on the respondent's identity.

42. The method of claim 39, comprising generating the response component based upon the type of human ability challenge selected.

43. The method of claim 33, further comprising selecting the human ability challenge from a plurality of stored human ability challenges.

44. The method of claim 43, wherein the step of selecting comprises randomly selecting the human ability challenge.

45. The method of claim 33, comprising providing a request for authentication for gaining access to a computerized resource, receiving an authentication code, and verifying the code responsive to the request for authentication if the received response to the human ability challenge matches the response component.

46. The method of claim 33, comprising receiving a request for access to a computerized resource and providing access to the resource only if the received response to the human ability challenge matches the response component.

47. The method of claim 33, comprising requesting user confirmation of an action and accepting user confirmation only if the received response to the human ability challenge matches the response component.

48. The method of claim 33, wherein the step of presenting a human ability challenge comprises presenting one or more graphical images representing the response component.

49. The method of claim 33, wherein the step of presenting a human ability challenge comprises presenting a plurality of graphical images representing identifiable objects and presenting a cognitive question regarding the plurality of graphical images, wherein the response component represents an answer to the question.

50. The method of claim 33, wherein the step of presenting a human ability challenge comprises presenting an audio file reciting a question, wherein the response component represents an answer to the question.

51. The method of claim 33, wherein the step of presenting a human ability challenge comprises presenting a noisy textual image displaying the response component.

52. The method of claim 33, wherein the step of presenting a human ability challenge comprises presenting a natural language question, wherein the response component represents an answer to the natural language question.

53. The method of claim 33, wherein the step of presenting the human ability challenge comprises transmitting the human ability challenge from a server to a client.

54. The method of claim 53, comprising encrypting the response component and transmitting the human ability challenge with the encrypted response component.

55. The method of claim 54, wherein the step of comparing comprises decrypting the encrypted response component and comparing the decrypted response component to the received response.

56. The method of claim 53, wherein the step of receiving a response to the human ability challenge comprises transmitting the response from the client to the server.

57. The method of claim 53, comprising hashing the response component and transmitting the human ability challenge with the hashed response component.

58. The method of claim 57, wherein the step of comparing comprises hashing the received response and comparing the hashed received response to the hashed response component.

59. A system employed in discriminating an action performed by a human from automatic computerized action, the system comprising:
a first set of computer program instructions for presenting a human ability challenge having a response component, the human ability challenge having distorted content to reduce the possibility of computerized identification of the content;
a second set of computer program instructions for receiving a response to the human ability challenge; and
a third set of computer program instructions for comparing the received response to the response component to thereby help determine whether the received response was provided by a human.

60. The system of claim 59, wherein the first set of computer program instructions resides on a server and the second set of computer program instructions resides on a client connectable to the server.

61. The system of claim 60, wherein the server comprises a proxy server positioned between an application server and the client.

62. The system of claim 60, wherein the server comprises an application server.

63. The system of claim 59, wherein the first, second and third sets of computer program instructions reside on a single computer.

64. In an on-line system, a method for reducing automated access, the method comprising:
allowing on-line access to data;
presenting a human ability challenge using an output device in response to a request for access to data, the human ability challenge having distorted content to reduce the possibility of computerized identification of the content;
receiving an answer to the human ability challenge; and
verifying that the answer satisfies the human ability challenge before allowing access to data.
